(19) United States
(12) Patent Application Publication
(10) Pub. No.: US 2008/0125029 A1
(43) Pub. Date: May 29, 2008

(54) AutoCellSafe - A method for the selective disabling of cellular communications while a motor vehicle is being operated.

(76) Inventor: Douglas Macalister Kernan, Los Gatos, CA (US)

Correspondence Address: DOUGLAS M. KERNAN, 16121 SHORT ROAD, LOS GATOS, CA, 95032, US

(21) Appl. No.: 11/563,681

(22) Filed: Nov. 28, 2006

(51) Int. Cl. H04K 3/00

(52) U.S. Cl. 455/1

(57) ABSTRACT

AutoCellSafe (ACS) is a method to allow for the selective disabling of cellular communications while a motor vehicle is being driven. The implementation is such that the inbound and outbound communication to a cellular hand set would be blocked when the ignition circuit of the motor vehicle was closed and none of the described override capabilities have been employed. The override capabilities would consist of one or more of the following: an electronic device, an electromechanical device, a mechanical key, and/or an override code.

AutoCellSafe (ACS) is a method to allow for the selective disabling of cellular communications while a motor vehicle is being driven. The implementation is such that the inbound and outbound communication to a cellular hand set would be blocked when the ignition circuit of the motor vehicle was closed (the motor vehicle is running) and none of the described override capabilities have been employed.

A practical example of the implementation would be associated with younger drivers. It has been statistically illustrated that younger drivers are a greater risk when behind the wheel and that distractions, increasingly in the form of cellular phone-based communications, are leading to higher accident rate in this demographic. These communications are taking the form of both verbal and text messaging. While this scenario is especially applicable to younger drivers, it is by no means exclusive to them. Legislation has been enacted in several states prohibiting the use of a cellular communication device, without a hands-free capability, while operating a motor vehicle. Additionally, employers who are responsible for claims against employees operating motor vehicles while working are faced with an increased level of risk when said employees utilize cellular communications while driving.

The method claimed is such that the inbound and outbound communication to a cellular hand set would be blocked under the following conditions:
The motor vehicle is running. ACS would be enabled with the ignition of the engine and disabled when the car and/or its electrical system are turned off; and
An override “key” is not present. ACS would be enabled as in 1 above and disabled when an override “key” is present. The override key may take one or more of the following forms:
(1) A distinct electro-mechanical device;
(2) An electro-mechanical device embedded in the ignition key;
(3) An electro-mechanical switch integrated into a cellular “hands free” cradle for the cellular phone;
(4) An electro-mechanical switch integrated into the transmission of the motor vehicle, such that putting the motor vehicle in PARK would enable the override key;
(5) A mechanical switch integrated into a cellular “hands free” cradle for the cellular phone;
(6) A code entered into the ACS.

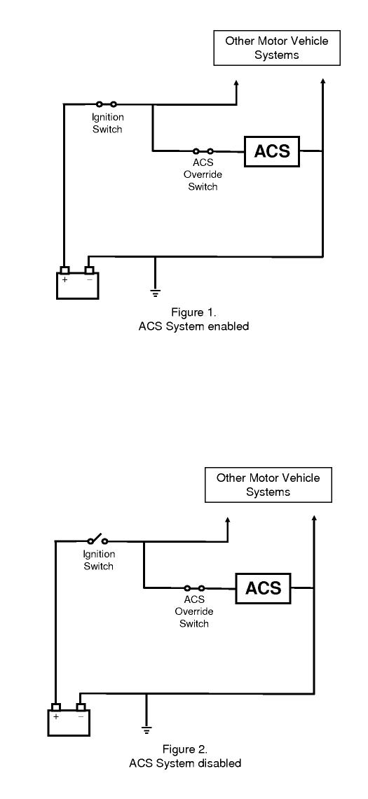

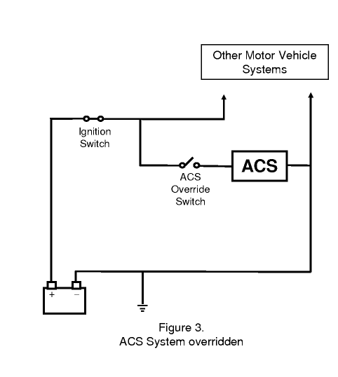

The system would be enabled when both of the above conditions are true, as displayed in FIG. 1. The system would be disabled when either the motor vehicle ignition and electrical systems are turned off, as displayed in FIG. 2; or when the ACS override “key” is present, as displayed in FIG. 3.

The electro-mechanical device would operate substantially similar to devices used to mitigate car theft. In the case of an embedded device, the concept would be to have multiple ignition keys, some of which are enabled with the embedded device and some that are not.

The implementation would be applicable for both an aftermarket product or as an OEM option from motor vehicle manufacturers.

Key implementation features:
Range: The ACS range must be such that it is only applicable in the 0-10 foot range, so as not to affect cellular communications outside the motor vehicle in which the ACS is operating.
Override Capability: The ACS may allow a user determined override capability, in addition to any automated on/off capability.

What is claimed is:

1. A method for the disabling of cellular communications of a cellular communications system while in use in an operating motor vehicle.

2. The method of claim 1, said method comprising a system to disable the communications via jamming of the cellular communications.

3. The method of claim 1, said method comprising a system to disable the communications through the use of protocols or command sequence supported within the cellular communications system.

4. A method for overriding the method of claim 1, said method comprised of a mechanical switch mechanism.

5. A method for overriding the method of claim 1, said method comprised of an electromechanical switch mechanism.

6. A method for overriding the method of claim 1, said method comprised of an electronic switch mechanism.
